(19) United States
(12) Patent Application Publication
(10) Pub. No.: US 2026/0294153 A1
(43) Pub. Date: Oct. 1, 2026

(54) BEVERAGE CREATOR DEVICE AND METHOD

(71) Applicant: HCL Technologies Limited, New Delhi (IN)

(72) Inventors: Shant kumar, Bengaluru (IN); Yuvraj D Patil, Kolhapur (IN)

(21) Appl. No.: 19/419,476

(22) Filed: Dec. 15, 2025

(30) Foreign Application Priority Data
Mar. 25, 2025 (IN) 202511027684

(51) Int. Cl. A47J 19/02; A23N 1/02

(52) U.S. Cl. CPC A47J 19/025; A23N 1/02; A47J 19/023; A47J 19/027

(57) ABSTRACT

This disclosure relates to a beverage creator device and method thereof. The beverage creator device may include a plurality of compartments. Further, each compartment may include a container configured to store the food matter, a beverage-extracting mechanism connected to the container, and a dual-directional horizontal auger disposed within the container. Furthermore, a dual-directional horizontal auger may include a first coil and a second coil. The first coil and the second coil, when rotated collectively in a first direction, are configured to transfer the food matter to the beverage-extracting mechanism to create the beverage.

### DESCRIPTION

### Technical Field

This disclosure relates generally to the field of beverages creation, and more particularly to a beverage creator device and method thereof.

### BACKGROUND

Beverage creators and dispensing devices may be configured to extract fresh beverages from food matter such as but not limited to fruits, vegetables, and the like. The beverage creator devices have been developed over the years for both home and commercial markets. However, existing beverage creator devices tend to be large, expensive, unportable, and unsuitable for home or small retail environments. Additionally, existing beverage creator devices are designed to extract beverages from a single food matter at a time, creating arduousness in making custom blends of mixed beverages. Moreover, the existing beverage creator devices do not offer the capability to process food matter in a way that allows food matter to be served as cut pieces for direct consumption.

Therefore, there is a pressing need to address the above shortcomings and provide a beverage creator device that is versatile and a user-friendly device that can meet a wider range of consumer needs.

### SUMMARY

In an embodiment, a beverage creator device to create a beverage of a food matter is disclosed. The beverage creator device may include a plurality of compartments.

Further, each compartment may include a container which may be configured to store the food matter, a beverage-extracting mechanism connected to the container, and a dual-directional horizontal auger disposed within the container. Furthermore, the dual-directional horizontal auger may include a first coil and a second coil. The first coil and the second coil, when rotated collectively in a first direction, may be configured to transfer the food matter to the beverage-extracting mechanism to create the beverage.

In an embodiment, a method of creating a beverage from a food matter is disclosed. The method may include rotating, in a first direction, a dual-directional horizontal auger disposed in a container configured to store the food matter. Further, the dual-directional horizontal auger may include a first coil and a second coil. Further, the first coil and the second coil when rotated collectively in the first direction may be configured to transfer the food matter to a beverage-extracting mechanism coupled to the container for creating the beverage.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1A illustrates a perspective view of a beverage creator device, in accordance with some embodiments of the present disclosure.

FIG. 1B illustrates a schematic view of the beverage creator device, in accordance with some embodiments of the present disclosure.

FIG. 2 illustrates a schematic view of a compartment with a centrifugal squeezer in the beverage creator device, in accordance with some embodiments of the present disclosure.

FIG. 3 illustrates a schematic view of the compartment with a masticating squeezer in the beverage creator device, in accordance with some embodiments of the present disclosure.

FIG. 4 illustrates a schematic view of the compartment with a twin-gear squeezer in the beverage creator device, in accordance with some embodiments of the present disclosure.

FIG. 5 illustrates a schematic view of the compartment with a cold-pressed squeezer in the beverage creator device, following some embodiments of the present disclosure.

FIG. 6 illustrates a functional block diagram of the beverage creator device, in accordance with some embodiments of the present disclosure.

FIG. 7 illustrates a functional module diagram of the beverage creator device, in accordance with some embodiments of the present disclosure.

FIG. 8 illustrates a flowchart of an implementation of a shutter operation in the beverage creator device, in accordance with some embodiments of the present disclosure.

FIG. 9 illustrates another flowchart of the implementation of the shutter operation in the beverage creator device, in accordance with some embodiments of the present disclosure.

FIG. 10 illustrates a flowchart of the implementation of a methodology for detecting food matter spoilage using one or more gas sensors in the beverage creator device, in accordance with some embodiments of the present disclosure.

FIG. 11 illustrates a flowchart of the implementation of a methodology for detecting a level of waste in a waste collector of the beverage creator device, in accordance with some embodiments of the present disclosure.

FIG. 12 illustrates a flowchart of the method of creating a beverage from a food matter in a beverage creator device, in accordance with some embodiments of the present disclosure.

FIG. 13 illustrates a flowchart of the method of dispensing food matter from the beverage creator device, in accordance with some embodiments of the present disclosure.

FIG. 14 illustrates a flowchart of the method of creating a mixed beverage from a food matter in a beverage creator device, in accordance with some embodiments of the present disclosure.

FIG. 15 illustrates a flowchart of the method of dispensing mixed food matter from a beverage creator device, in accordance with some embodiments of the present disclosure.

FIG. 16 illustrates an exemplary computing system that may be employed to implement processing functionality for various embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

As explained earlier, existing beverage creator devices tend to be large, expensive, unportable, and unsuitable for home or small retail environments. Additionally, existing beverage creator devices are designed to extract beverages from a single food matter at a time, creating arduousness in making custom blends of mixed beverages. Moreover, existing beverage creator devices do not offer the capability to process food matter in a way that allows food matter to be served as cut pieces for direct consumption.

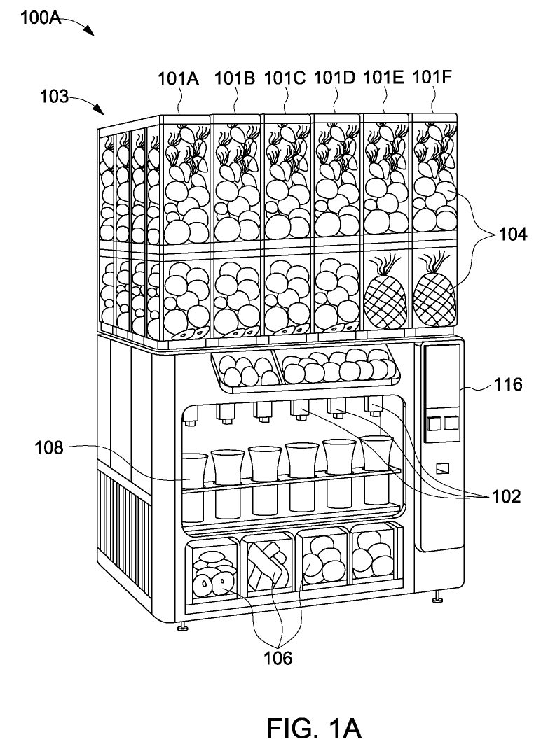

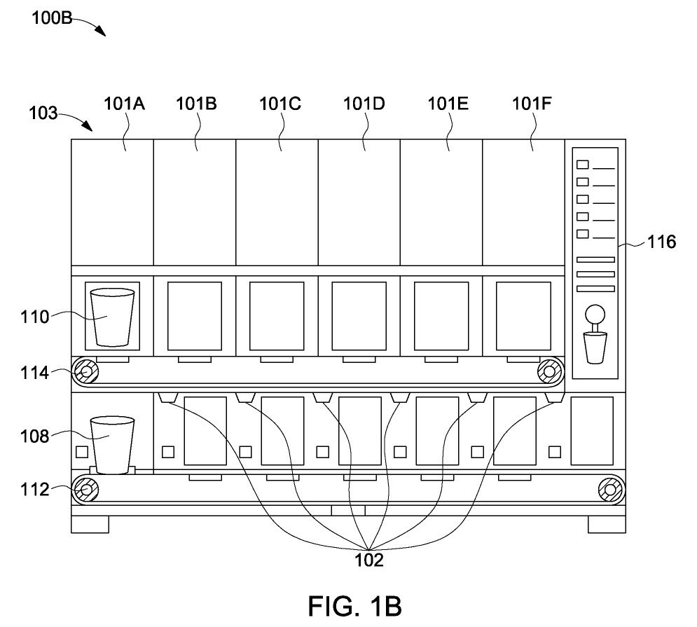

Hence, to meet a wider range of consumer needs a beverage creator device to create a beverage of a food matter is disclosed. The beverage creator device may include a plurality of compartments. Each compartment may include a container configured to store the food matter, a beverage-extracting mechanism connected to the container, and a dual-directional horizontal auger disposed within the container. The dual-directional horizontal auger may include a first coil and a second coil. The first coil and the second coil, when rotated collectively in a first direction, are configured to transfer the food matter to the beverage-extracting mechanism to create the beverage. The following paragraphs describe the present disclosure with reference to FIGS. 1-16.

FIG. 1A illustrates a perspective view 100A of a beverage creator device 103, in accordance with some embodiments of the present disclosure. FIG. 1B illustrates a schematic view 100B of the beverage creator device 103, in accordance with some embodiments of the present disclosure. The beverage creator device 103 may include a plurality of compartments 101. Each compartment from the plurality of compartments 101 may be configured to store a food matter 104. The food matter 104 may include but not limited to whole fruits, whole vegetables, cut fruits, cut vegetables, milk, coffee, flavoring syrup, flavoring condiments, and the like. Each compartment from the plurality of compartment 101 may store a single food matter or a different combination of food matter of the same category. For example, compartment 101A may store U type of food matter, compartment 101B may store V type of food matter, compartment 101C may store W type of food matter, compartment 101D may store X type of food matter, compartment 101E may store Y type of food matter, and compartment 101F may store Z type of food matter. In another embodiment, compartments 101A, 101B, 101C, 101D, 101E, and 101F may store only U type of food matter. In another embodiment, compartments 101A and 101B may store U type of food matter, compartments 101C and 101D may store Z type of food matter, and compartments 101E, and 101F may store only V type of food matter and any combinations thereof.

In an exemplary embodiment, the plurality of compartments may store food matter such as cut fruits and cut vegetables. Accordingly, the U-type food matter may include fruits with high water content and less fiber content such as but not limited to citrus fruits, melons, and the like. The V-type food matter may include fruits with moderate water content and moderate fiber content such as but not limited to kiwi, pomegranate, berries, and the like. The W-type food matter may include fruits with low water content and high fiber content such as but not limited to apples, pears, guavas, and the like. Accordingly, the X-type food matter may include vegetables with high water content and less fiber content such as but not limited to cucurbits, tomatoes, and the like. The Y-type food matter may include vegetables with moderate water content and moderate fiber content such as but not limited to beetroot, carrots, and the like. The Z-type food matter may include vegetables with low water content and high fiber content such as but not limited to spinach, lettuce, and the like. As may be appreciated, the containers 101A-101F may not be limited to the type of food matters U-type and Z-type, and may also include other type of food matters not disclosed herein.

Further, each compartment from the plurality of compartments 101 may include a beverage extractor. The beverage extractor may include but not limited to a blender, a centrifugal squeezer, a twin gear squeezer, a masticating squeezer, a cold-pressed squeezer, and the like. It is to be noted that a type of beverage extractor may be based on the type of food matter 104 stored within each compartment. For example, the compartment storing food matter 104 with high water content may include the centrifugal squeezer to extract the beverage from the food matter 104. The compartment storing food matter 104 with high fiber content may include the twin gear squeezer to extract the beverage from the food matter 104. The compartment storing food matter 104 with moderate water content may include the masticating squeezer to extract the beverage from the food matter 104. Particularly, the cold pressed squeezer may be installed in the compartment storing any type of food matter 104 to extract the beverage from the food matter 104. Further, the beverage creator device 103 may include a plurality of beverage dispensers 102 to dispense the extracted beverage from the food matter 104 into a receptacle 108. The beverage creator device 103 may further include a plurality of food matter dispensers 106 to serve the food matter 104 into the receptacle 110 for direct consumption. Further, the beverage creator device 103 may include a first moving mechanism 114 and a second moving mechanism 114. The first moving mechanism 112 may be configured to sequentially move the receptacle 108 to at least one beverage dispenser from the plurality of beverage dispensers 102 to receive the extracted beverage from at least one beverage dispenser 102. Accordingly, the second moving mechanism 114 may be configured to sequentially move the receptacle 110 to at least one food matter dispenser from the plurality of food matter dispensers 106 to collect the dispensed food matter 104 from at least one food matter dispenser for direct consumption. It is to be noted that the first moving mechanism 112 and the second moving mechanism 114 may include but not limited to a conveyor belt, robotic arms, and the like. Further, the beverage creator device 103 may include a user interface 116. The user may interact and give inputs to the beverage creator device 103 via the user interface 116. The inputs may include but not limited to type of beverage, quantity of beverages, beverage preferences, beverage customization, type of food matter, quantity of food matter, food matter preferences, food matter customization, and the like.

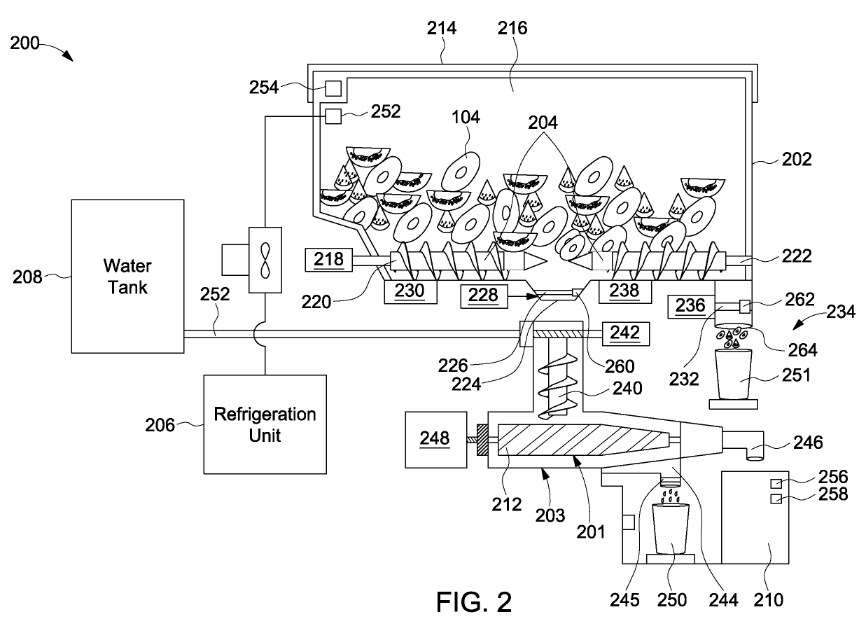

Referring now to FIG. 2, which illustrates a schematic view 200 of a compartment with a centrifugal squeezer 212 in the beverage creator device 103, in accordance with some embodiments of the present disclosure. The beverage creator device 103 may include a centralized refrigeration unit 206 and a water tank 208. Further, each compartment may include a container 202, a dual directional horizontal auger 204, a waste collector 210, a food dispensing mechanism 234, and a beverage extracting mechanism 201.

In an embodiment, the beverage creator device 103 may be divided into a plurality of compartments 101. Each compartment 101 may include a container 202 having a predefined volumetric capacity and may be configured to store the food matter 104. The container 202 of each compartment may be configured to store a single food matter 104 from any one of the U-type to Z-type as listed above, or in other words, any one of whole fruits, whole vegetables, cut fruits, cut vegetables, milk, coffee, flavoring syrup, flavoring condiments, and the like. The container 202 may further include a lid 214 to cover an upper portion of the container 202. The lid 214 may be opened allowing access to an interior of the container 202, enabling easy loading of the container 202 with the food matter 104. Once the food matter 104 is loaded within the container 202, the lid 214 may be closed again to ensure the container 202 remains sealed and secure, to preserve the food matter 104 stored therein.

Further, the container 202 may be designed based on the characteristics of the food matter 104 to be stored therein such as but not limited to density, hardness, fiber content, freshness, water content, and the like. Further, the refrigeration unit 206 may be coupled to each container 202 of the plurality of compartments 101 to prolong the shelf life of the food matter 104 stored therein. To further elaborate, the container 202 may further include a sub-container 216 configured to store the food matter 104. The sub-container 216 may be connected to refrigeration unit 206. The refrigeration unit 206 may be configured to circulate cold air to, or around the sub-container 216 to maintain a predefined temperature within the sub-container 216 to keep the food matter 104 in a fresh condition for a longer period of time. Hence, the sub-container 216 remains unaffected by the external fluctuations, providing consistent storage conditions to prolong shelf life of the food matter 104. It is to be noted that the predefined temperature maintained in each container 202 may be same or different based on the type of food matter 104 stored therein.

In an embodiment, each compartment may include the beverage-extracting mechanism 201 connected to the container 202 and the food dispensing mechanism 234 connected to the container 202. Additionally, each container 202 in the plurality of compartments 101 may include the dual-directional horizontal auger 204 disposed within the container 202. The dual-directional horizontal auger 204 may be coupled to an electric motor 218. The electric motor 218 may be configured to drive the dual-directional horizontal auger 204 to rotate and independently move the food matter 104 from the container 202 towards either the beverage-extracting mechanism 201 or the food dispensing mechanism 234. The dual-directional horizontal auger 204 may further include a first coil 220 and a second coil 222. Accordingly, when the first coil 220 and the second coil 222 may be rotated collectively by the electric motor 218 , or each of the first coil 220 or the second coil 222 may be individually operated by a motor. Moreover, the first coil 220 or the second coil 222 may be configured to transfer the food matter 104 from the container 202 to the beverage-extracting mechanism 201 to create the beverage.

The first coil 220 and the second coil 222 may include opposite helical coils, i.e., the helix angle of the helical coil of the first coil 220 may be opposite to the helix angle of the helical coil of the second coil 222. Further, the first direction may be a clockwise direction and the second direction may be an anticlockwise direction. when the first coil 220 and the second coil 222 are rotated collectively by the electric motor 218 in a first direction, the food matter may be converged and transferred to the to the beverage-extracting mechanism 201 to create the beverage. Conversely, when the first coil 220 and the second coil 222 are rotated collectively by the electric motor 218 in a second direction, the food matter 104 may be transferred from the container 202 to the food dispensing mechanism 234 to dispense the food matter 104.

Additionally, each container 202 may include a central guide 224 disposed at a base of the container 202 between the first coil 220 and the second coil 222. Particularly, the first coil 220 and the second coil 222 when rotated by the electric motor 218 in the first direction, guide the food matter 104 from the container 202 to the central guide 224. Further, the central guide 224 may include a central shutter 226 which may be configured to allow a predefined quantity of the food matter 104 to be transferred to the beverage-extracting mechanism 201. The central shutter 226 may be coupled to an electric motor 228 which may be configured to open or close the central shutter 226. Further, to determine the predefined quantity of food matter, the central guide 224 may be incorporated with a plurality of first load sensors 230. The plurality of first load sensors 230 incorporated within the central guide 224 measures and weighs the quantity of food matter 104 collected by the central guide 224. Once a weight measured by the plurality of first load sensors 230 reaches a predefined weighing value, the electric motor 228 may be operated. Upon operation, the electric motor 228 may be configured to open the central shutter 226 to transfer the predefined quantity of the food matter 104 to the beverage-extracting mechanism 201. It is to be noted, once the predefined quantity of food matter 104 is transferred to the beverage-extracting mechanism 201, the electric motor 228 may close the central shutter 226 to prevent any further transfer of the food matter 104 to the beverage-extraction mechanism 201.

In an embodiment, the food dispensing mechanism 234 may include a front shutter 232 connected to the container 202 and a food matter dispenser 264 coupled to the front shutter 232. The food dispensing mechanism 234 may further include an electric motor 236 coupled to the front shutter 232 which may be configured to open or close the front shutter 232. Particularly, the first coil 220 and the second coil 222 when rotated collectively in a second direction may transfer the food matter 104 from the container 202 to the front shutter 232. The front shutter 232 may be configured to dispense a predefined quantity of food matter via a food matter dispenser 246 into a receptacle 251. Hence, to determine the predefined quantity of food matter, the front shutter 232 may be incorporated with a plurality of second load sensors 238. The plurality of second load sensors 238 measures and weighs the quantity of food matter 104 collected by the front shutter 232. Once a weight measured by the plurality of second load sensors 238 reaches a predefined weighing value, the electric motor 236 may be operated. Upon operation, the electric motor 236 may open the front shutter 232 to dispense the predefined quantity of food matter 104 via the food matter dispenser 264 into the receptacle 251 for direct consumption. It is to be noted that once the food matter 104 is dispensed, the electric motor 236 may close the front shutter 232 to prevent any further dispensing of the food matter 104 into the receptacle 251.

It is to be noted, that the predefined weighing value of the central guide 224 may be determined based on the amount of beverage to be dispensed, as specified by an user input. For example, if the user input is 300 ml of beverage, the predefined weighing value for the central guide 224 may be set to 600 gm of food matter 104. Accordingly, the predefined weighing value of the front shutter 232 may be determined based on the quantity of food matter to be dispensed, as specified by the user input. For example, if the user input is 250 gm of food matter, the predefined weighing value for the front shutter 232 may be set to 250 gm of food matter 104.

Further, as explained earlier, each compartment may include the beverage-extracting mechanism 201. Further, the beverage-extracting mechanism 201 may include a vertical auger 240, a beverage extractor 203, a beverage dispenser 244, a waste dispenser 246, and a waste collector 210.

The vertical auger 240 may be configured to transfer the food matter 104 received from the central shutter 226 to the beverage extracting mechanism 201. Further, the vertical auger 240 may be coupled to an electric motor 242. The electric motor 242, when driven, may be configured to enable rotation of the vertical auger 240 and independently transfer the food matter 104 received from the central shutter 226 to the beverage extractor 203. Further, the beverage extractor 203 may be configured to receive the food matter 104 from the vertical auger 240 and extract beverages from the received food matter 104. Further, the beverage-extracting mechanism 201 may include a beverage dispenser 244 which may be configured to dispense the extracted beverage into a receptacle 250. The beverage-extracting mechanism 201 may further include a waste collector 210 coupled to the beverage extractor 203 which may be configured to receive a food pulp produced after extraction of the beverage from the food matter 104.

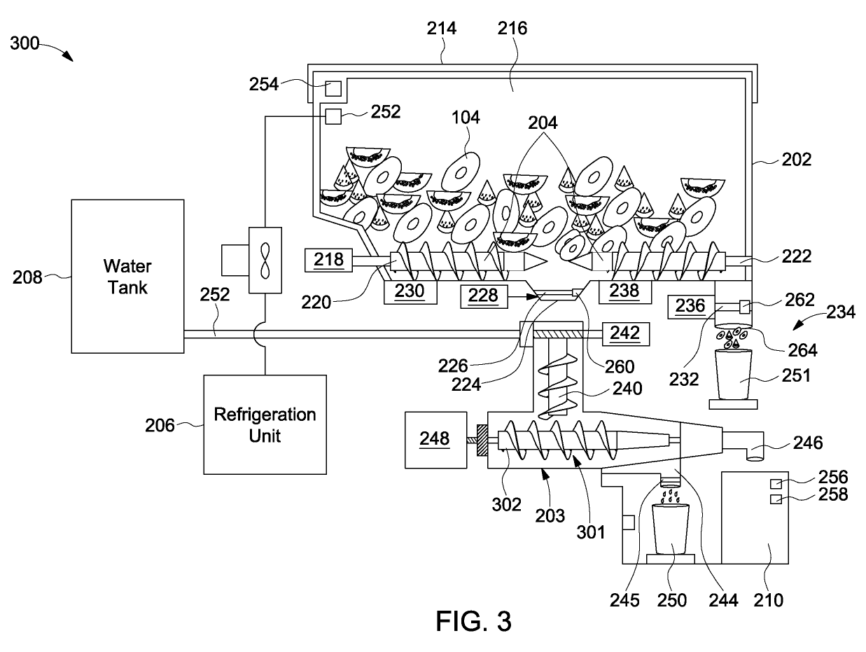

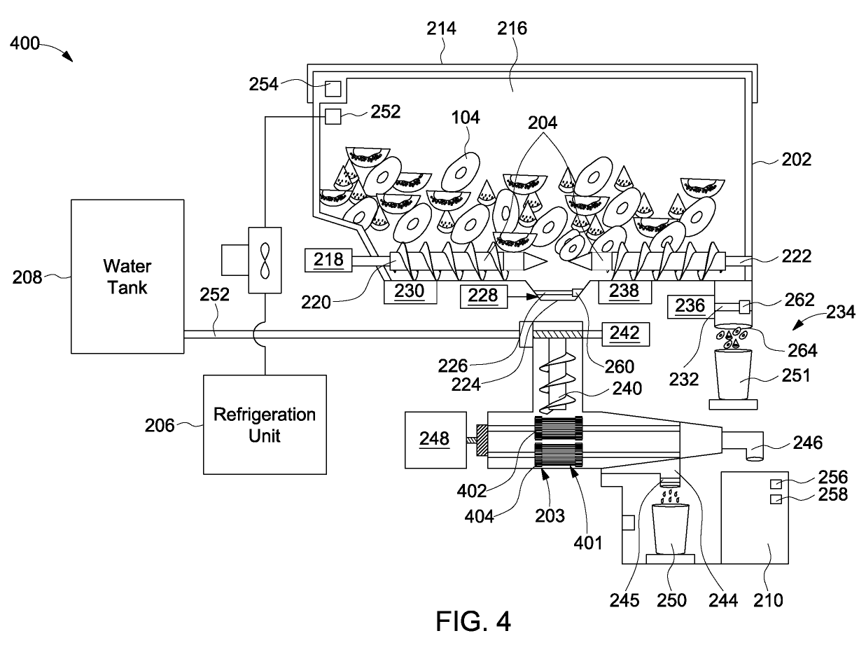

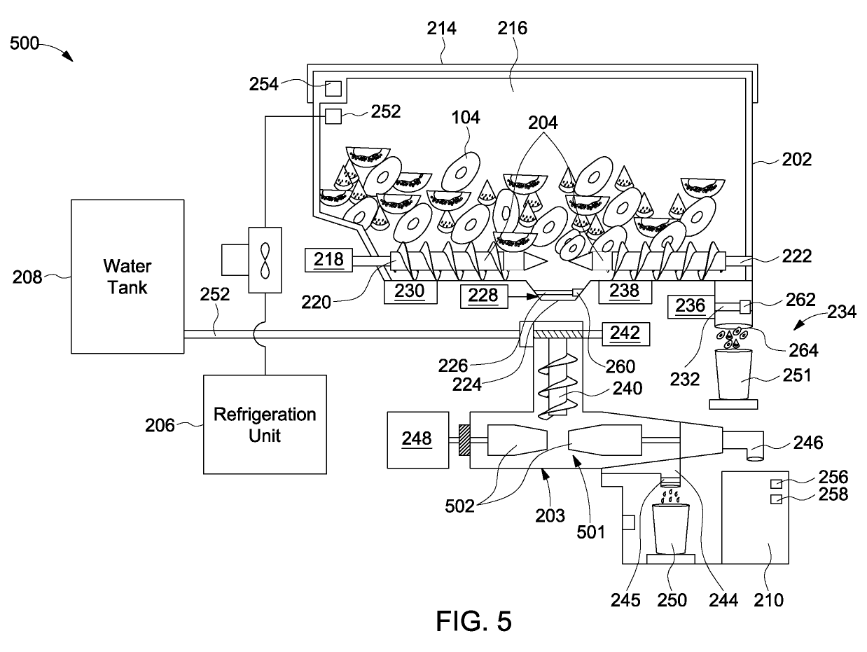

Further, each beverage extractor 203 in the plurality of compartments 101 may include any one of a blender, a centrifugal squeezer 212, a masticating squeezer 301 (refer to FIG. 3), a twin gear squeezer 401 (refer to FIG. 4), and a cold-pressed squeezer 501 (refer to FIG. 5).

In an exemplary embodiment, the beverage extractor 203 may include the centrifugal squeezer 212. The centrifugal squeezer 212 may operate by using centrifugal force to extract beverages from the food matter 104. The centrifugal squeezer 212 may include a feeding chute (not shown in figure), a plurality of blades (not shown in figure), a mesh filter 245, and a centrifugal basket (not shown in figure). The feeding chute coupled to the vertical auger 240 may be configured to receive the food matter 104 from the vertical auger 240. The size of the feeding chute may be based on the size of food matter 104 received by the feeding chute. For example, for receiving whole food matter or larger pieces of food matter the feeding chute may be wider in size. Conversely, for receiving cut food matter or smaller pieces of food matter the feeding chute may be narrower in size. Further, the centrifugal squeezer 212 may include the centrifugal basket which is a rotating disc coupled to the feeding chute. The centrifugal basket may include the plurality of blades disposed within the centrifugal basket. The plurality of blades may be configured to receive the food matter 104 from the feeding chute and shred the food matter 104 into the food pulp to extract the beverages. The centrifugal basket may further include the mesh filter 245 disposed at the outer surface of the centrifugal basket which may be configured to filter the beverage from the food pulp.

Particularly, the food matter 104 received by the feeding chute is transferred to the centrifugal basket due to gravity where the beverage extraction process begins. The centrifugal basket collects the food matter 104 from the feeding chute to extract beverages from the food matter 104. An electric motor 248 coupled to the centrifugal basket may be configured to rotate the centrifugal basket at high speed. As a result, the plurality of blades disposed within the centrifugal basket shreds the food matter 104 received from the feeding chute into smaller pieces to extract the beverage from the food matter 104. The resulting beverage mixture (i.e. combination of the beverage and the food pulp) may be forced through the mesh filter 245 by the centrifugal force generated by the rotation of the centrifugal basket. The mesh filter 245 may enable the beverage to pass through the mesh filter 245 while trapping the food pulp. The filtered beverage may flow through the beverage dispenser 244 into a receptacle 250 for immediate consumption. Further, the food pulp left after the extraction of the beverage may automatically travel towards the waste dispenser 246 to dispense the food pulp into the waste collector 210.

Further, to prevent beverages from dripping from the beverage dispenser 244 and contamination entering through the beverage dispenser 244, the beverage dispenser 244 may be incorporated with a seal to prevent dripping of the beverage therefrom. The seal may include but not limited to a pressure burstable seal or a peel-away seal that may be manually removed before usage and the like. In addition to incorporating the seal, the beverage dispenser 244 may also include drip poof features to avoid dripping after beverage dispensing. The drip-proof features may include but not limited to a valve, a capillary, a deformable material capable of deforming to close a position, absorbent materials located within the beverage dispenser, retractable dispenser, a zipper, and the like.

With continued reference to FIG. 2, as explained earlier, each compartment may include the waste collector 210 coupled to the beverage extractor 203. The waste dispenser may be configured to receive the food pulp produced after the extraction of the beverage from the food matter 104. Further, the waste collector 210 may be divided into two sections, one section for solid waste and the other section for liquid waste. The division due to such sections eliminate undesired effects such as fermentation of the waste due to solid wastes in liquid waste which may decay and result in unpleasant odors. The waste collector 210 may further be connected to a dispensing tube for draining waste water to such as but not limited to a sewer, drains, and the like. The waste collector 210 may also include a compressing unit for compressing the solid waste to reduce the required space for the solid waste.

Further, each compartment 101 may include a self-cleaning mechanism. The self-cleaning mechanism may include a water tank 208 coupled to the beverage extracting mechanism 201. The water tank 208 may be configured to pump water to the beverage extracting mechanism 201 to clean the beverage extracting mechanism 201 after each cycle of the extraction of the beverages. Each compartment 101 may further include a conduit 254 coupled to the water tank 208 which may be configured to transmit water from the water tank 208 to the beverage extracting mechanism 201 for cleaning the beverage extracting mechanism 201. After each cycle of the extraction of the beverage from the food matter 104, the water may be pumped through the conduit 252 into the beverage extracting mechansim 201 to wash the beverage extractor 203. After washing, all waste water may move either to the waste collector 210 or to the sewage. The self-cleaning mechanism may also include a viper or a reverse flow mechanism to wash away any accumulated pulp, seeds, and the like in the beverage extracting mechanism 201 into the waste collector 210. Once the cleaning is done, the beverage extracting mechanism 201 may be ready for starting a new cycle of extracting the beverage from the food matter 104.

Referring now to FIG. 3, which illustrates the schematic view 300 of a compartment with a masticating squeezer 301 in the beverage creator device 103, in accordance with some embodiments of the present disclosure. In another exemplary embodiment, the beverage extractor 203 may include the masticating squeezer 301. The masticating squeezer 301 may be operated using a slow grinding process to extract beverages from the food matter 104. The masticating squeezer 301 may include an auger 302 to crush and press the food matter 104 slowly. The masticating squeezer 301 may include a feeding chute, an auger 302, and a mesh filter 245. The feeding chute may be configured to receive the food matter 104 from the vertical auger 240. Further, the auger 302 may be configured to crush and grind the food matter 104. The food matter 104 received by the feeding chute may be transferred to the auger 302 under the influence of gravity where the beverage extraction process begins. The auger 302 receives the food matter 104 from the feeding chute to extract beverages from the food matter 104. Further, the masticating squeezer 301 may include an electric motor 248 coupled to the auger 302 which may be configured to rotate the auger 302 at a low speed ranging from about 40 to about 103 RPM. As the auger 302 is slowly rotated by the electric motor 248, the auger 302 crushes and grinds the food matter 104 received from the feeding chute, thereby extracting the beverage from the food matter 104. The resulting mixture (i.e. mixture of beverage and food pulp) passes through the mesh filter 245 disposed at the beverage dispenser 244. The mesh filter 245 enables the beverage to pass through the mesh filter 245 while trapping the food pulp. The filtered beverage is dispensed into a receptacle 250 through the beverage dispenser 244 for immediate consumption. Further, the food pulp left after the extraction of the beverage may be pushed by the auger 302 towards the waste dispenser 246 to dispense the food pulp into the waste collector 210.

Referring now to FIG. 4, which illustrates the schematic view 400 of a compartment with a twin-gear squeezer 401 in the beverage creator device 103, in accordance with some embodiments of the present disclosure. In another exemplary embodiment, the beverage extractor 203 may include the twin gear squeezer 401. The twin gear squeezer 401 may operate by using a pair of gears 402, 404 to extract beverage from the food matter. The twin-gear squeezer 401 may include a feeding chute (not shown in figure), a pair of gears 402, 404, a pusher, and a mesh filter 245. As explained earlier, the feeding chute coupled to the vertical auger 240 may be configured to receive the food matter 104 from the vertical auger 240.

Further, the pair of gears 402, 404 may be configured to crush, mash, and squeeze the food matter 104 received from the feeding chute to extract the beverage. Further, the first gear 402 rotates in a first direction direction and the second gear 404 rotates in a second direction. It is to be noted that the first direction is opposite to the second direction. Particularly, the food matter received by the feeding chute is transferred to the pair of gears 402, 404 due to gravity where the beverage extraction process begins. The pair of gears 402, 404 receive the food matter 104 from the feeding chute to extract beverages from the food matter 104. Further, the pair of gears 402, 404 interlocks and mash the food matter 104 as the food matter 104 moves therebetween. The twin gear squeezer 401 may further include an electric motor 248 coupled to the pair of gears 402, 404 which may be configured to rotate the pair of gears 402, 404 at a low speed ranging from about 40 RPM to about 103 RPM. As the pair of gears 402, 404 is slowly rotated by the electric motor 248, the pair of gears 402, 404 crushes and grinds the food matter 104 received therebetween. Due to the forces received by the pair of gears 402, 404 the beverage may be extracted from the food matter 104. The resulting mixture (i.e. mixture of beverage and food pulp) passes through a mesh filter 245 disposed at the beverage dispenser 244. The mesh filter 245 enables the beverage to pass through the mesh filter 245 while trapping the food pulp. The filtered beverage is dispensed into the receptacle 250 through the beverage dispenser 244 for immediate consumption. Further, the food pulp left after the extraction of the beverage may automatically travel towards the waste dispenser 246 to dispense the food pulp into the waste collector 210.

Referring now to FIG. 5, which illustrates the schematic view 500 of a compartment with a cold-pressed squeezer in the beverage creator device 103, in accordance with some embodiments of the present disclosure. In another exemplary embodiment, the beverage extractor 203 may include the cold-pressed squeezer 501. The cold-pressed squeezer 501 operates using a hydraulic press mechanism. The cold-pressed squeezer 501 may include a feeding chute (not shown in figure), a mesh filter 245 , and a pair of hydraulic presses 502. As explained earlier, the feeding chute coupled to the vertical auger 240 may be configured to receive the food matter 104 from the vertical auger 240.

Further, the cold-pressed squeezer 501 may include the pair of hydraulic presses 502 which may be configured to crush and grind the food matter 104 received from the feeding chute. The food matter 104 received by the feeding chute is transferred to the pair of hydraulic presses 502 due to gravity where the beverage extraction process begins. The pair of hydraulic presses 502 may be configured to apply a predefined amount of pressure on the food pulp received therebetween from the feeding chute to extract the beverage of the food matter 104. Further, the cold-pressed squeezer 501 may include an electric motor 248 coupled to the pair of hydraulic presses 502 which may be configured to operate the pair of hydraulic presses 502. As the pair of hydraulic presses 502 is operated by the electric motor 248, the pair of hydraulic presses 502 applies a predefined amount of pressure on the food pulp which extracts beverages from the food matter 104 received by the feeding chute, thereby extracting the beverage from the food matter 104. The resulting mixture (i.e. mixture of beverage and food pulp) passes through a mesh filter 245 disposed at the beverage dispenser 244. The mesh filter 245 enables the beverage to pass through the mesh filter 245 while trapping the food pulp. The filtered beverage is dispensed into the receptacle 250 through the beverage dispenser 244 for immediate consumption.

Referring to FIG. 1 to 5, each type of beverage extractor 203 may be configured to extract the beverage from a single food matter 104. However, one or more beverage extractors 203 may operate collectively to dispense one or more combinations of beverages from two or more food matter into the receptacle 250. For example, to dispense a mixed beverage of U-type food matter and Z-type food matter 104 from the beverage creator device 103, upon placing the receptacle 250 under the beverage dispenser 244, the beverage extractor 203 of compartment 101A may be operated to dispense a predefined amount of beverage of U-type food matter 104 into the receptacle 250. Further, the the receptacle 250 may be moved through a first moving mechanism 112 to compartment 101F. Further, the beverage extractor 203 of compartment 101F may be operated to dispense the predefined amount of beverage of Z-type food matter 104 into the receptacle 250. Hence, the mixed beverage of U-type food matter and Z-type food matter is received in the receptacle 250 for unmediated consumption.

Correspondingly, for example, to dispense a mixed food salad of X-type food matter and Y-type food matter from the beverage creator device 103 for direct consumption. Upon placing the receptacle 251 under the food matter dispenser 264, the front shutter 232 of compartment 101D may be operated to dispense a predefined quantity of X-type food matter 104 into the receptacle 251. Further, the receptacle 251 may be moved through a second moving mechanism 114 to compartment 101E. Further, the front shutter 232 of compartment 101F may be operated to dispense the predefined quantity of Y-type food matter 104 into the receptacle 250. Hence, the mixed food salad of X-type food matter and Y-type of food matter 104 is received in the receptacle 251 for direct consumption.

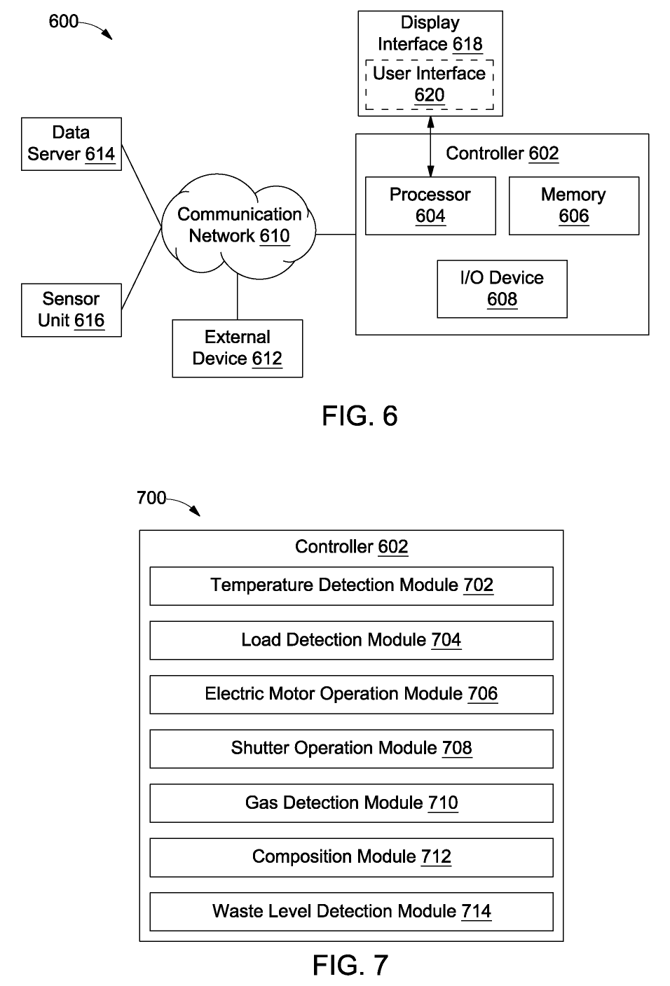

Referring now to FIG. 6, which illustrates a functional block diagram 600 of the beverage creator device 103, in accordance with some embodiment of the present disclosure. The system 600 may include a controller 602, an external device 612, a data server 614, a sensor unit 616, and a display interface 618 communicably coupled to each other through a wired or wireless communication network 610. The controller 602 may include a processor 604, a memory 606, and an input/output (I/O) device 608.

In an embodiment, examples of processor(s) 604 may include but are not limited to, an Intel^{®} Itanium^{®} or Itanium 2 processor(s), or AMD^{®} Opteron^{®} or Athlon MP^{®} processor(s), Motorola^{®} lines of processors, Nvidia^{®}, FortiSOC™ system on a chip processors or other future processors.

In an embodiment, the memory 606 may store instructions that, when executed by the processor 604 may cause the processors to execute instructions adapted to manage and monitor different components of the beverage creator device 103. The controller 602 may be configured to receive user input, process data from the components of the beverage creator device 103 and perform the extracting of the beverage from the food matter 104. The memory 606 may also store various data (for example, user inputs, user details, beverage recommendations, beverage preferences, payment details, nutritional values, calories level and the like) that may be captured, processed, and/or required by the beverage creator device 103.

In an embodiment, the memory 606 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The disclosed methods and systems may be implemented on a conventional or a general-purpose computer system, such as a personal computer (PC) or server computer.

In an embodiment, the I/O device 608 may comprise of variety of interface(s), for example, interfaces for data input and output devices, and the like. The I/O device 608 may facilitate inputting of instructions by a user communicating with the computing device 602. In an embodiment, the I/O device 608 may be wirelessly connected to the controller 602 through wireless network interfaces such as Bluetooth®, infrared, or any other wireless radio communication known in the art. In an embodiment, the I/O device 608 may be connected to a communication pathway for one or more components of the controller 602 to facilitate the transmission of inputted instructions and output results of data generated by various components such as, but not limited to, processor(s) 604 and memory 606.

In an embodiment, the data server 614 may be enabled in a remote cloud server or a co-located server and may include a database to store an application, a large language model (LLM) and other data necessary for the system 600 to perform beverage creation. In an embodiment, the data server 614 may store data input by an external device 112 (e.g., prompts) or output generated by the controller 602. It is to be noted that the application may be designed and implemented as either a web application or a software application. The web application may be developed using a variety of technologies such as HTML, CSS, JavaScript, and various web frameworks like React, Angular, or Vue.js. It may be hosted on a web server and accessible through standard web browsers. On the other hand, the software application may be a standalone program installed on users' devices, which may be developed using programming languages such as Java, C++, Python, or any other suitable language depending on the platform. In an embodiment, the controller 602 may be communicably coupled with the data server 614 through the communication network 610.

In an embodiment, the communication network 610 may be a wired or a wireless network or a combination thereof. The communication network 610 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 610 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the communication network 610 can include a variety of network devices, including routers, bridges, servers, controllers, storage devices, and the like.

In an embodiment, the controller 602 may receive a user input for creating beverages from an external device 612 through the communication network 610. In an embodiment, the controller 602 and the external device 612 may be a computing system, including but not limited to, a smart phone, a laptop computer, a desktop computer, a notebook, a workstation, a server, a portable computer, a handheld, or a mobile device. In an embodiment, the controller 602 may be, but not limited to, in-built into the external device 612 or may be a standalone controller.

The system 600 may further include the display interface 618. The user may interact with the system 600 may interact with a user via a user interface 620 accessible via the display interface 618.

In an embodiment, the sensor unit 616 may be communicably coupled to the communication network 610. The sensor unit 106 may be configured to measure the performance of different components of the beverage creator device 103 and allow deep learning within the controller 602 for predicting malfunctioning or failure in advance. The sensor unit 616 may be configured to determine one or more parameters from one or more parts of the beverage creator device 103. The one or more parameters determined by the sensor unit 616 may be transmitted to the controller 602 which when processed by the processor 604 causes the processor 604 to ensure proper functioning and maintenance of the beverage creator device 103. It is to be noted that the one or more parameters may include but not limited to temperature within the container 202, concentration of gases, operational state, weight, level of water in water tank 208, and the like. The sensor unit may include a temperature sensor 252, a first gas sensor 254, a second gas sensor 258, a plurality of first load sensors 230, a plurality of second load sensors 238, a waste level sensor 256, a first shutter sensor 260, and a second shutter sensor 262.

In an exemplary embodiment, each container 202 in the plurality of compartments 101 may include the temperature sensor 252. The termperature sensor 252 may be configured to monitor a temperature within each container 202. The temperature sensor 252 may include but not limited to thermistors, thermocouples, bimetallic temperature sensors, capacitive temperature sensors, and the like. Each container 202 in a plurality of compartments 101 may be maintained at a predefined temperature based on the type of food matter 104 stored therein. In an event of any fluctuations in the temperature within the container 202 due to the opening of the lid 214, which may allow ambient air to enter and potentially raise the temperature within the container 202, the temperature sensor 252 may detect the temperature change within the container and may transmit the data to the controller 602. The controller 602 in case the temperature within the container 202 exceeds the predefined temperature, transmit a command to the refrigeration unit 206. The refrigeration unit 206 upon receiving the command by the controller 602 may supply high volume of cold air into the container 202 to restore the predefined temperature with`in the container 202.

The container 202 may further include a first gas sensor 254 which may be configured to detect spoiling, or decaying of food matter 104 within the container 202. The first gas sensor 254 may include but not limited to ethylene gas sensors, methane gas sensors, ammonia sensors, and the like. Particularly, when the food matter 104 stored within the container 202 begins to spoil, the spoiled food matter releases gases such as but not limited to methane, ammonia, ethylene, and the like. The first gas sensor 254 may be configured to detect one or more gases within the container 202 and transmit the collected data to the controller 602. The controller 602 upon determing the concentration of gases within the container 202 exceeding the predefined gas threshold may display a message on the user interface 620, alerting the user to remove the spoiled food matter from the container 202.

For example, in case the container 202 is storing U-type food matter and a kilogram of food matter begins to spoil or decay. The food matter may release from about 10 ppm to about 100 ppm of methane in the early stages of decay which may be detected by the plurality of first gas sensors 254. The plurality of first gas sensors 254 may transmit the collected data to the controller 602. The controller 602 upon determining the concentration of methane gas exceeding 100 ppm within the container 202, may display a message on the user interface 620, alerting the user to remove the spoiled food matter from the container 202.

In an embodiment, the container 202 may further include a plurality of first load sensors 230 incorporated within the central guide 224 of the container 202. The plurality of first load sensors 230 may be configured to measure the weight of the food matter 104 collected by the central guide 224. The container 202 may further include a plurality of second load sensors 238 incorporated within the front shutter 232 of the container 202. The plurality of second load sensors 238 may be configured to measure the weight of the food matter 104 collected by the front shutter 232. It is to be noted that the plurality of first load sensors 230 and the plurality of second load sensors 238 may include but not limited to strain gauge load sensors, piezoelectric load sensors, capacitive load sensors, hydraulic load sensors and the like.

The container 202 may further include a first shutter sensor 260 coupled to the central shutter 226 which may be configured to determine an operational status of the central shutter 226. The first shutter sensor may include but not limited to limit switches, hall effect sensors, optical sensors, pressure sensors, and the like. As explained earlier, the first coil 220 and the second coil 222 when rotated collectively in the first direction may transfer the food matter 104 from the container 202 to the central guide 224. The plurality of first load sensors 230 coupled to the central guide 224 measures and weighs the quantity of food matter 104 collected by the central guide 224. The plurality of first load sensors 230 transmits the collected data to the controller 602. Accordingly, when the weight measured by the plurality of first load sensors 230 reaches a predefined weighing value, the controller 602 may transmit a command to an electric motor 228. The electric motor 228 upon receiving the command by the controller 602, may open the central shutter 226 for a predefined interval of time to transfer the food matter 104 into a beverage-extracting mechanism 201. Further, the first shutter sensor 260 upon detecting an opening of the central shutter 226, may transmit the data to the controller 602. The controller 602, upon determining the opening of the central shutter 226 beyond the predefined interval of time, may transmit the command to the electric motor 228. The electric motor 228 upon receiving the command by the controller 602 may close the central shutter 226 to prevent any further transfer of the food matter 104 into the beverage-extracting mechanism 201.

In an embodiment, the container 202 may include a second shutter sensor 262 coupled to a front shutter 232 which may be configured to determine an operational condition of the front shutter 232. The second shutter sensor 262 may include but not limited to limit switches, hall effect sensors, optical sensors, pressure sensors, and the like. As explained earlier, the first coil 220 and the second coil 222 when rotated collectively in a second direction may transfer the food matter 104 from the container 202 to the front shutter 232. The plurality of second load sensors 238 coupled to the front shutter 232 measures and weighs the quantity of food matter 104 collected by the front shutter 232 and transmits the collected data to the controller 602. Accordingly, when the weight measured by the plurality of second load sensors 238 reaches a predefined weighing value, the controller 602 may transmit a command to an electric motor 236. The electric motor 236 upon receiving the command by the controller 602, may open the front shutter 232 for a predefined interval of time to dispense the food matter 104 via food matter dispenser 264 into the receptacle 251. Further, the second shutter sensor 262, upon detecting an opening of the front shutter 232, may transmit the data to the controller 602. The controller 602, upon determining the opening of the front shutter 232 beyond the predefined interval of time, may transmit the command to the electric motor 236. The electric motor 236 upon receiving the command by the controller 602 may close the front shutter 232 to prevent any further dispensing of the food matter 104 into the receptacle 251.

Further, the waste collector 210 of the beverage extraction mechanism 201 may include a waste level sensor 256 coupled to the controller 602 which may be configured to detect a level of waste in the waste collector 210. The waste level sensor 256 may include but not limited to ultrasonic level sensors, capacitive level sensors, optical level sensors, and the like. When the level of waste within the waste collector 210 reaches a predefined waste level value, the controller 602 may display a message on the user interface 620, alerting the user to empty the waste collector 210.

The waste collector 210 may further include a second gas sensor 258 coupled to the waste collector 210 which may be configured to detect a decay of the food pulp within the waste collector 210. The second gas sensor 258 may include but not limited to ethylene gas sensors, methane gas sensors, ammonia sensors, and the like. When the food pulp within the waste collector 210 begins to decay, the decayed food pulp releases gases such as but not limited to methane, ammonia, ethylene, and the like. The second gas sensor 258 may be configured to detect one or more gases within the waste collector 210 and transmit the collected data to the controller 602. The controller 602 upon determing the concentration of gas within the waste collector 210 exceeding a predefined gas threshold may display a message on the user interface 620, alerting the user to empty the waste collector 210.

For example, in case the waste colletor 210 is storing a kilogram of food pulp, which begins to spoil. The food pulp may release about 10 ppm to about 100 ppm of methane during the decaying process which may be detected by the plurality of second gas sensors 258. The plurality of second gas sensors 258 may transmit the collected data to the controller 602. The controller 602 upon determining the concentration of methane gas exceeding 100 ppm within the waste collector 210, may display a message on the user interface 620, alerting the user to empty the waste collector 210.

Referring now to FIG. 7, which illustrates a functional module diagram 700 of the beverage creator device 103, in accordance with some embodiments of the present disclosure. The controller 602 of the beverage creator device 103 may include a temperature detection module 702, a load detection module 704, an electric motor operation module 706, a shutter operation module 708, a gas detection module 710, a combination module 712 and a waste level detection module 714.

The temperature detection module 702 may be configured to receive sensor data from a temperature sensor 252 disposed within each container 202 of the plurality of compartments 101. Further, based on the sensor data, the temperature detection module 702 may be configured to maintain the temperature of the container 202 at a predefined temperature. In the event of any fluctuations in the temperature within the container 202 due to the opening of the lid 214, ambient air will be allowed to enter and potentially raise the temperature within the container 202. The temperature sensor 252 may detect the temperature change within the container and may transmit the data to the temperature detection module 702. The temperature detection module 702, in case the temperature within the container 202 exceeds the predefined temperature, may cause the refrigeration unit 206 to supply high volume of cold air into the container 202 to restore the predefined temperature within the container 202.

The load detection module 704 may be configured to receive sensor data from a plurality of first load sensors 230, and the plurality of second load sensors 238. The plurality of first load sensors 230 may be configured to measure the weight of food matter 104 to be transferred by the central guide 224 to a beverage extracting mechanism 201 to create a beverage. Conversely, the plurality of second load sensors 238 may be configured to measure the weight of food matter to be dispensed by the food matter dispenser 264 for direct consumption. Further, based on the sensor data, the load detection module 704 may transmit the command to the electric motor operation module 706.

The electric motor operation module 706 may be configured to receive commands from the load detection module 704 to operate either a central shutter 226 or a front shutter 232. If the weight of the food matter 104 measured by the plurality of first load sensors 230 in the central guide 224 of the container 202 reaches a predefined weighing value, the load detection module 704 may transmit a command to the electric motor operation module 706. The electric motor operation module 706 upon receiving the command may operate an electric motor 228 to open the central shutter 226 for a predefined interval of time. As a result, the food matter measured by the plurality of first load sensors 230 may be transferred to the beverage extracting mechanism 201.

In another embodiment, in case the weight of the food matter 104 measured by the plurality of second load sensors 238 in the front shutter 232 of the container 202 reaches the predefined weighing value, the load detection module 704 may transmit a command to the electric motor operation module 706. The electric motor operation module 706 upon receiving the command may operate the electric motor 236 to open the front shutter 232 for a predefined interval of time. As a result, the food matter 104 measured by the plurality of second load sensors 238 may be dispensed via a food matter dispenser 264 into the receptacle 251 for direct consumption.

The shutter operation module 708 may be configured to receive sensor data corresponding to a first shutter sensor 260 and a second shutter sensor 262. The first shutter sensor 260 may be configured to monitor the operation of the central shutter 226 and the second shutter sensor 262 may be configured to monitor the operation of the front shutter 232. The first shutter sensor 260 may detect an opening of the central shutter 226 on the condition that the central shutter 226 is opened by the electric motor 228 to transfer the food matter into the beverage extracting mechanism 201. In case the central shutter 226 remains open beyond the predefined interval of time, the shutter operation module 708 may transmit a command to the electric motor operation module 706 to close the central shutter 226.

Accordingly, the second shutter sensor 262 detects an opening of the front shutter 232 on the condition that the front shutter 232 is opened by the electric motor 236 to dispense the food matter via food matter dispenser 264. Further, in case, the front shutter 232 remains open beyond the predefined interval of time, the shutter operation module 708 may transmit the command to the electric motor operation module 706 to close the front shutter 232.

The gas detection module 710 may be configured to receive sensor data corresponding to a first gas sensor 254 and a second gas sensor 258. The first gas sensor 254 may be configured to detect the spoiling, or decaying of food matter 104 stored within the container 202. Conversely, the second gas sensor 258 may be configured to detect the decaying of the food pulp within the waste collector 210. Upon determing the concentration of one or more gases with the container 202 exceeding the predefined gas threshold, the gas detection module may be configured to display a message on a user interface 620, alerting a user to remove the spoiled food matter from the container 202. Accordingly, upon determing the concentration of one or more gases exceeding the predefined gas threshold within the waste collector 210, the gas detection module 710 may be configured to display the message on the user interface 620, alerting the user to empty the waste collector 210.

The composition module 712 may be configured to sequentially extract beverages from two or more food matter 104 in order to dispense a mixed beverage from the beverage creator device 103. The composition module 712 upon getting a user input, may transmit a command to two or more beverage extractors 203 to extract beverage from two or more food matter 104. For example, to dispense a mixed beverage of 30 ml of beverage from U-type food matter and 70 ml of beverage from Z-type food matter from the beverage creator device 103, the receptacle 250 may be placed under the beverage dispenser 244. The composition module 712 may operate the beverage extractor 203 of compartment 101A to dispense 30ml of beverage from U-type food matter 104 into the receptacle 250. Further, the composition module 712 may move the receptacle 250 through a first moving mechanism 112 to compartment 101F. Further, the composition module 712 may operate the beverage extractor 203 of compartment 101F to dispense 70ml of beverage from Z-type food matter 104 into the receptacle 250. Hence, the mixed beverage of U-type food matter and Z-type food matter 104 is received in receptacle 250 for immediate consumption.

Additionally, the composition module 712 may be configured to sequentially dispense two or more food matter 104 from the beverage creator device 103. The composition module 712 upon getting the user input, may transmit the command to two or more front shutters 232 to dispense two or more food matter 104. For example, to dispense a mixed food salad of 103gm of X-type of food matter and 150gm of Y-type food matter from the beverage creator device 103, the receptacle 251 may be placed under the food matter dispenser 264. The composition module 712 may operate the electric motor 236 to open the front shutter 232 of compartment 101D to dispense 103gm of X- type food matter into the receptacle 251. Further, the composition module 712 may move the receptacle 251 through a second moving mechanism 114 to compartment 101E. Further, the composition module 712 may operate the electric motor 236 to open the front shutter 232 of compartment 101F to dispense 150gm of Y-type food matter into the receptacle 251. Hence, the mixed food salad of X-type food matter and Y-type food matter is received in the receptacle 251 for direct consumption.

The waste level detection module 714 may be configured to receive sensor data corresponding to a waste level sensor 256 disposed within the waste collector 210. The waste level sensor 256 may be configured to detect a level of waste within the waste collector 210. When the level of waste within the waste collector 210 reaches a predefined waste level value, the waste level detection module 714 may be configured to display a message on the user interface 620, alerting the user to empty the waste collector 210.

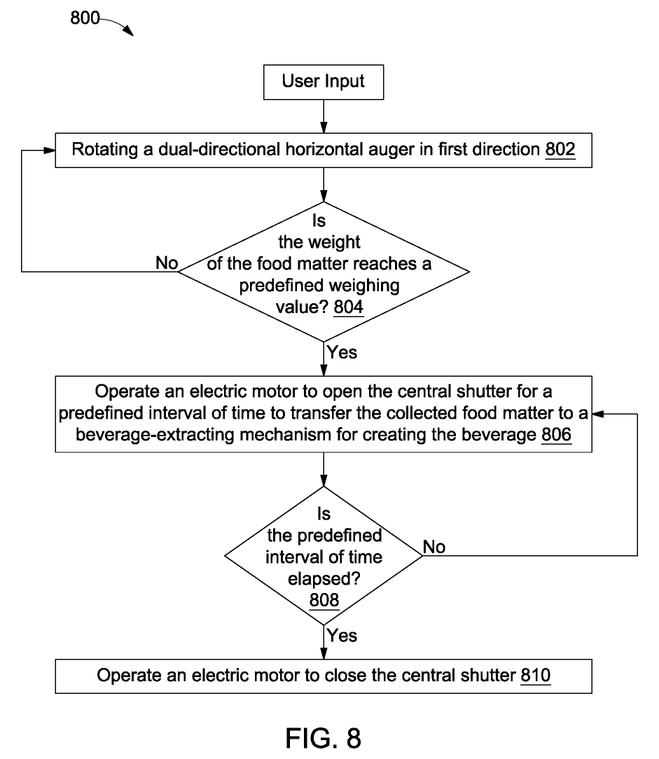

Referring now to FIG. 8, which illustrates a flowchart 800 of the implementation of a shutter operation in a beverage creator device 103, in accordance with some embodiments of the present disclosure.

At step 802, after receiving a user input, a controller 602 may be configured to operate an electric motor 218 to rotate a first coil 220 and the second coil 222 collectively in a first direction. Upon rotation, the first coil 220 and the second coil 222 may be configured to guide the food matter 104 from a container 202 to a central guide 224. The central guide 224 may include a plurality of first load sensors 230 to measure and weigh the quantity of food matter 104 collected by the central guide 224. The plurality of first load sensors 230 may transmit a data such as weight of the food matter 104 collected by the central guide 224 to the controller 602.

At step 804, the controller may determine if the food matter 104 collected by the central guide 224 reaches a predefined weighing value determined by the plurality of first load sensors 230. In case the food matter 104 collected by the central guide 224 reaches the predefined weighing value, at step 806, the controller may operate the electric motor 228. The electric motor 228 upon operation may open a central shutter 226 for a predefined interval of time to transfer the collected food matter 104 to the beverage extracting mechanism 201. Conversely, in case the food matter 104 collected by the central guide 224 is below the predefined weighing value, the controller 602 may continue to rotate the first coil 220 and the second coil 222 in the first direction to guide more food matter 104 from the container 202 to the central guide 224. Further, at step 808, the controller may evaluate whether the predefined interval of time has elapsed. Upon confirmation of the time being elapsed, the methodology may proceed to step 810. At step 810, the controller 602, may operate the electric motor 228 to close the central shutter 224.

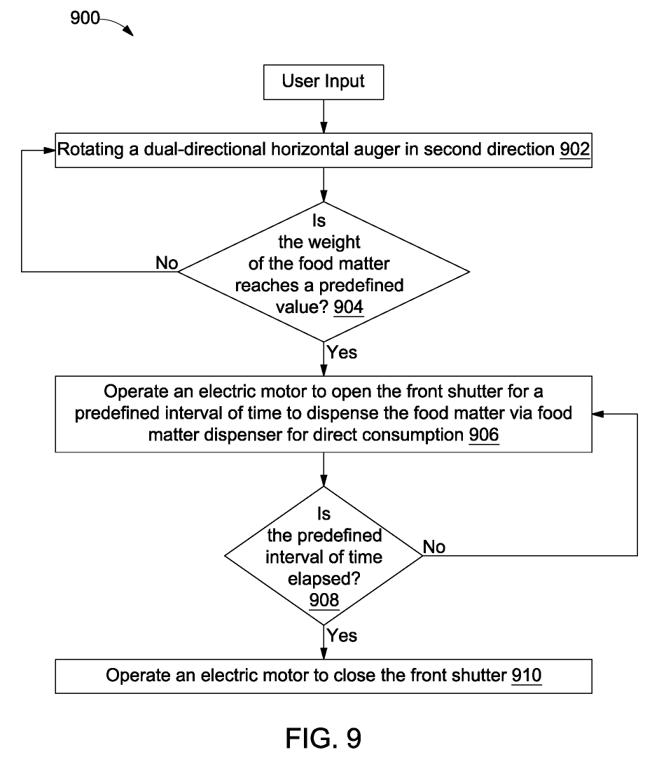

Referring now to FIG. 9, which illustrates another flowchart 900 of the implementation of the shutter operation in a beverage creator device 103, in accordance with some embodiments of the present disclosure. At step 902, after receiving a user input, a controller 602 may be configured to operate an electric motor 218 to rotate a first coil 220 and the second coil collectively in a second direction. Upon rotation, the first coil 220 and the second coil 222 may be configured to guide the food matter 104 from a container 202 to a front shutter 232. The front shutter 232 may include a plurality of second load sensors 238 to measure and weigh the quantity of food matter 104 collected by the front shutter 232. The plurality of second load sensors 238 may transmit a data such as weight of the food matter 104 collected by the front shutter 232 to the controller 602.

At step 904, the controller may determine if the food matter 104 collected by the front shutter 232 reaches a predefined weighing value determined by the plurality of second load sensors 238. In case the food matter 104 collected by the front shutter 232 reaches the predefined weighing value, the controller 602, at step 906 may operate the electric motor 236. The electric motor 236 upon operation may open the front shutter 232 for a predefined interval of time to dispense the collected food matter 104 via food matter dispenser 264 into a receptacle 251 for direct consumption. Conversely, in case the food matter 104 collected by the front shutter 232 is below the predefined weighing value, the controller 602 may transmit a signal to continue the rotation of the first coil 220 and the second coil 222 in the second direction to guide more food matter 104 from the container 202 to the front shutter 232. Further, the controller 602, at step 908 may evaluate whether the predefined interval of time has elapsed. Upon confirmation of the time being elapsed, the methodology may proceed to step 910. At step 910, the controller 602 may operate the electric motor 236 to close the front shutter 232.

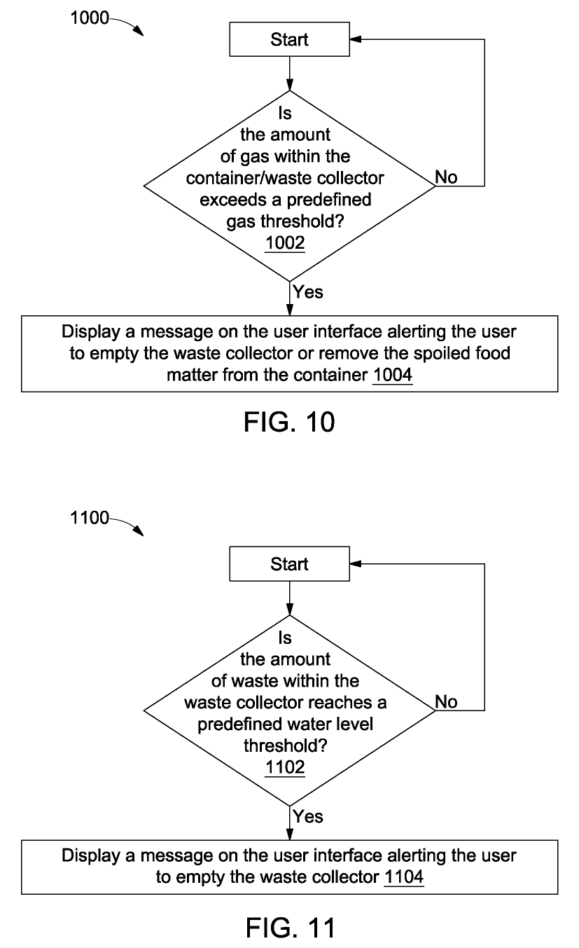

Referring now to FIG. 10, which illustrates a flowchart 1030 of the implementation of a methodology for detecting food matter spoilage using one or more gas sensors in a beverage creator device 103, in accordance with some embodiments of the present disclosure. At step 1032, a controller 602 may be configured to determine an amount of gases released during decaying of food matter 104 within the container 202 and the waste collector 210 using a first gas sensor 254 and a second gas sensor 258. Upon determining the concentration of one or more gases exceeding the predefined gas threshold within the container 202 by the first gas sensor 254, at step 1034, the controller 602 may display a message on the user interface 620 alerting the user to remove the spoiled food matter from the container 202. Accordingly, upon determining the concentration of one or more gases exceeding the predefined gas threshold within the waste collector 210 by the second gas sensor 258, at step 1034, the controller 602 may be configured to display a message on a user interface 620 alerting the user to empty the waste collector 210.

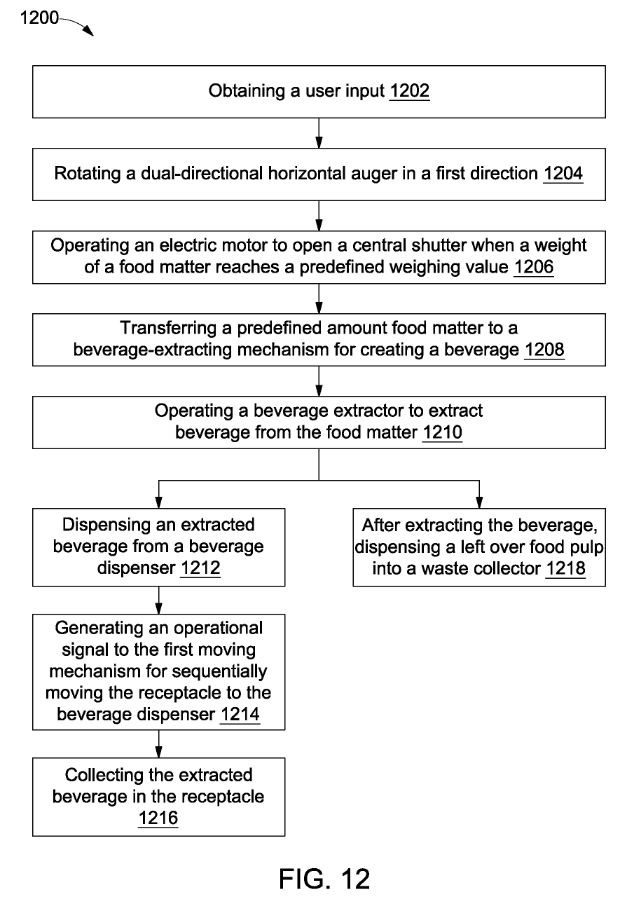

Referring now to FIG. 11, which illustrates a flowchart 1103 of the implementation of a methodology for detecting a level of waste in a waste collector 210 of the beverage creator device 103, in accordance with some embodiments of the present disclosure. At step 1102, the controller 602 may be configured to determine a level of waste within the waste collector 210. In case the amount of waste within the waste collector 210 reaches a predefined waste level value, the controller 602, at step 1104 may be configured to display a message on a user interface 620 alerting the user to empty the waste collector 210.

Referring now to FIG. 12, which illustrates a flowchart 1200 of the method of creating a beverage from a food matter 104 in the beverage creator device 103, in accordance with some embodiments of the present disclosure. The method may include a plurality of steps that may be performed by various modules of the controller 602 to create beverages from the beverage creator device 103.

At step 1202, a controller 602 may receive a user input either by a user interface 620 or by an external device 612. The user input may include but not limited to type of beverage, quantity of beverages, beverage preferences, beverage customization, and the like.

At step 1204, after receiving the user input, the controller 602 may be configured to operate an electric motor 218 to rotate a first coil 220 and a second coil 222 in a first direction. Upon rotation, the first coil 220 and the second coil 222 may be configured to guide the food matter 104 from a container 202 to a central guide 224. A plurality of first load sensors 230 of the central guide 224 may weigh the quantity of food matter 104 collected by the central guide 224. When the food matter 104 collected by the central guide 224 reaches a predefined weighing value, the controller 602, at step 1206 may operate an electric motor 228 to open a central shutter 226 for a predefined interval of time to transfer the food matter 104 into a beverage extracting mechanism 201. At step 1208, the collected food matter 104 is transferred to the beverage extracting mechanism 201 for creating the beverage. At step 1210, the controller 602 may operate an electric motor 248 to operate a beverage extractor 203 to extract beverage from the food matter 104 received by the central guide 224. At step 1212, the beverage extracted by the beverage extractor 203 may be dispensed through the mesh filter 245 via beverage dispenser 244. At step 1214, the controller 602 may generate an operational signal to the first moving mechanism 112 for moving the receptacle 250 to the beverage dispenser 244 . At step 1216, the extracted beverage may be collected via beverage dispenser 244 into the receptacle 250 for immediate consumption. Further, at step 1218, after extraction of the beverage from the food matter 104, the leftover food pulp may be dispensed via waste dispenser 246 into a waste collector 210.

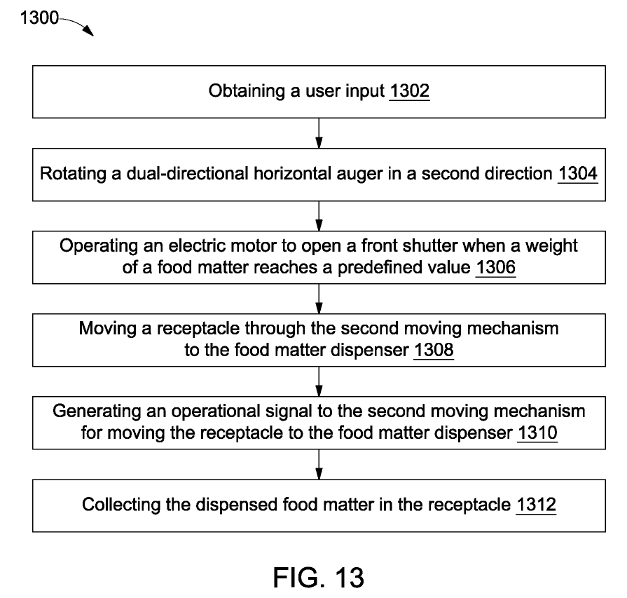

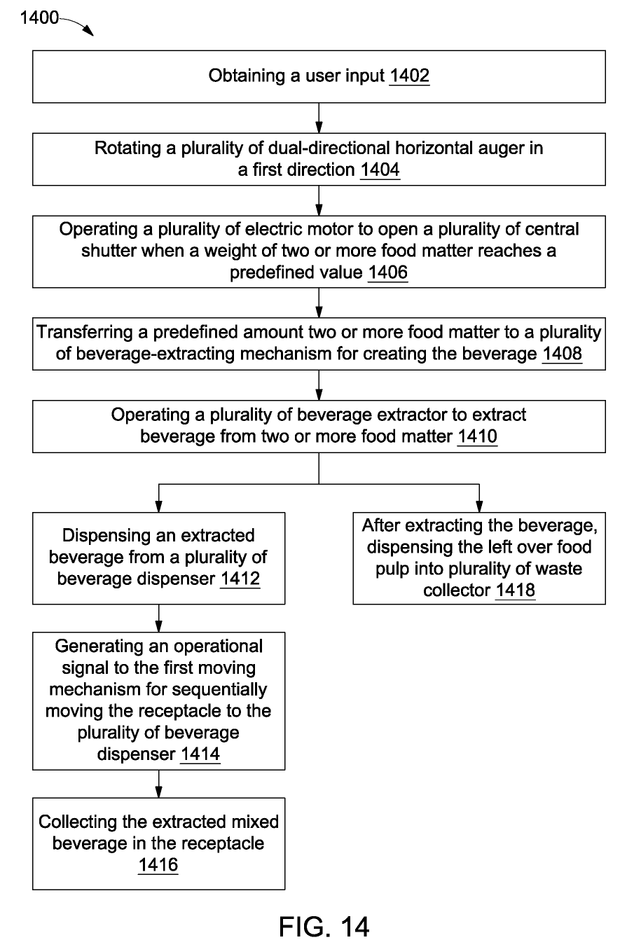

Referring now to FIG. 13, which illustrates a flowchart 1300 of the method of dispensing food matter 104 from the beverage creator device 103, in accordance with some embodiments of the present disclosure. The method may include a plurality of steps that may be performed by various modules of the controller 602 to dispense food matter 104 from the beverage creator device 103.

At step 1302, a controller 602 may receive a user input either by a user interface 620 or by an external device 612. The user input may include but not limited to type of food matter, quantity of food matter, food matter preferences, food matter customization, and the like. After receiving the user input, the controller 602, at step 1304 may be configured to operate an electric motor 218 to rotate a first coil 220 and the second coil 222 in a second direction. Upon rotation, the first coil 220 and the second coil 222 may be configured to guide the food matter 104 from a container 202 to a front shutter 232. A plurality of second load sensors 238 of the front shutter 232 weighs the quantity of food matter 104 collected by the front shutter 232. When the food matter 104 collected by the front shutter 232 reaches a predefined weighing value, the controller 602, at step 1306 may be configured to operate an electric motor 236 to open the front shutter 232 for a predefined interval of time to dispense the food matter 104 via food matter dispenser 264. At step 1308, the controller 602 may generate an operational signal to the second moving mechanism 114 for moving the receptacle 251 to the food matter dispenser 264 of the compartment. At step 1310, the food matter dispenser 264 may dispense the collected food matter 104. At step 1312, the dispensed food matter may be collected by the receptacle 251 for direct consumption.

Referring to FIG. 14, which illustrates a flowchart 1400 of the method of creating a mixed beverage from a food matter 104 in the beverage creator device 103, in accordance with some embodiments of the present disclosure. The method may include a plurality of steps that may be performed by various modules of the controller 602 to create mixed beverages from the beverage creator device 103.

At step 1402, a controller 602 may receive a user input either by a user interface 620 or by an external device 612. The user input may include but not limited to a combination of beverages, quantity of beverages, beverage preferences, beverage customization, and the like. After receiving the user input the controller 602, at step 1404 may be configured to sequentially operate a plurality of electric motors 218 to rotate a plurality of first coil 220 and plurality of second coil 222 in a first direction. Upon rotation, the plurality of first coil 220 and the plurality of second coil 222 may be configured to guide two or more food matter 104 from a plurality of container 202 to a plurality of central guide 224. A plurality of first load sensors 230 of the plurality of central guide 232 weighs the quantity of two or more food matter 104 collected by the plurality of central guide 224. When two or more food matter 104 collected by the plurality of central guide 224 reaches a predefined weighing value, the controller 602, at step 1406 may sequentially operate a plurality of electric motors 228. The plurality of electric motor 228 upon operation may open a plurality of central shutter 226 for a predefined interval of time to transfer the two or more food matter 104 to a plurality of beverage extracting mechanism 201. At step 1408, the collected two or more food matter 104 may be transferred to the plurality of beverage extracting mechanism 201 for creating the mixed beverage. At step 1410, the controller 602 may sequentially operate a plurality of electric motors 248 to operate a

plurality of beverage extractors 203 to extract beverages from two or more food matter 104 received by the plurality of central guide 224. At step 1412, the beverages extracted by the plurality of beverage extractor 203 may be dispensed via plurality of beverage dispenser 244. At step 1414, the controller 602 may generate an operational signal to the first moving mechanism 112 for sequentially moving the receptacle 250 to the plurality of beverage dispenser 244. At step 1416, the extracted beverages may be sequentially dispensed via the plurality of beverage dispenser 244 into the receptacle 250 for immediate consumption. Further, at step 1418 after extraction of the beverages from two or more food matter 104, the leftover food pulp may be sequentially dispensed via a plurality of waste dispenser 246 into a plurality of waste collector 210.

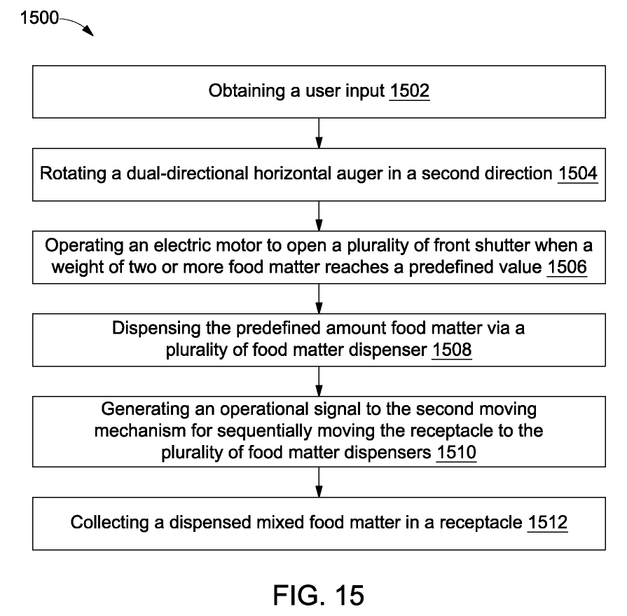

Referring now to FIG. 15, which illustrates a flowchart 1500 of the method of dispensing mixed food matter 104 from the beverage creator device 103, in accordance with some embodiments of the present disclosure. The method may include a plurality of steps that may be performed by various modules of the controller 602 to dispense food matter 104 from the beverage creator device 103.

At step 1502, a controller 602, may receive a user input either by a user interface 620 or by an external device 612. The user input may include but not limited to a combination of food matter, quantity of food matter, food matter preferences, food matter customization, and the like. After receiving the user input, the controller 602, at step 1504 may be configured to sequentially operate a plurality of electric motors 218 to rotate a plurality of first coil 220 and a plurality of second coil 222 in a second direction. Upon rotation, the plurality of first coil 220 and the plurality of second coil 222 may be configured to guide two or more food matter 104 from a plurality of container 202 to a plurality of front shutter 232. A plurality of second load sensors 238 of the plurality of front shutters 232 weighs the quantity of two or more food matter 104 collected by the plurality of front shutter 232. When two or more food matter 104 collected by the plurality of front shutter 232 reaches a predefined weighing value, the controller 602, at step 1506 may be configured to operate a plurality of electric motors 236. The plurality of electric motor 236 upon operation may open the plurality of front shutter 232 for a predefined interval of time to dispense the two or more food matter 104 via a plurality of food matter dispenser 264. At step 1508, two or more food matter 106 may be dispensed via the plurality of food matter dispenser 264. At step 1510, the controller 602 may generate an operational signal to the second moving mechanism 114 for sequentially moving the receptacle 251 to the plurality of food matter dispensers 264. Further, at step 1512, the dispensed two or more food matter 104 may be sequentially collected by the receptacle 251 via the plurality of food matter dispensers 264 for direct consumption.

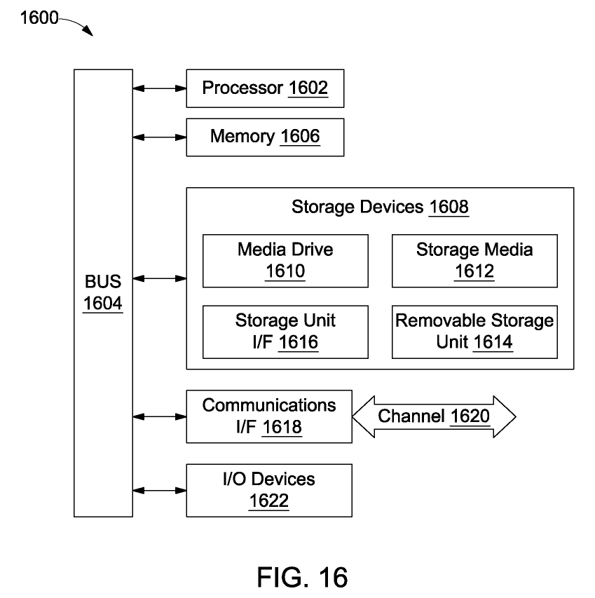

Referring now to FIG. 16, which illustrates an exemplary computing system 1600 that may be employed to implement processing functionality for various embodiments (e.g., as a SIMD device, client device, server device, one or more processors, or the like). Those skilled in the relevant art will also recognize how to implement the invention using other computer systems or architectures. The computing system 1600 may represent, for example, a user device such as a desktop, a laptop, a mobile phone, personal entertainment device, DVR, and so on, or any other type of special or general-purpose computing device as may be desirable or appropriate for a given application or environment. The computing system 1600 may include one or more processors, such as a processor 1602 that may be implemented using a general or special purpose processing engine such as, for example, a microprocessor, microcontroller or other control logic. In this example, the processor 1602 is connected to a bus 1604 or other communication medium. In some embodiments, the processor 1602 may be an Artificial Intelligence (AI) processor, which may be implemented as a Tensor Processing Unit (TPU), or a graphical processor unit, or a custom programmable solution Field-Programmable Gate Array (FPGA).

The computing system 1600 may also include a memory 1606 (main memory), for example, Random Access Memory (RAM) or other dynamic memory, for storing information and instructions to be executed by the processor 1602. The memory 1606 also may be used for storing temporary variables or other intermediate information during execution of instructions to be executed by the processor 1602. The computing system 1600 may likewise include a read only memory (“ROM”) or other static storage device coupled to bus 1604 for storing static information and instructions for the processor 1602.

The computing system 1600 may also include a storage device 1608, which may include, for example, a media drive 1610 and a removable storage interface. The media drive 1610 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 1612 may include, for example, a hard disk, magnetic tape, flash drive, or other fixed or removable medium that is read by and written to by the media drive 1610. As these examples illustrate, the storage media 1612 may include a computer-readable storage medium having stored therein particular computer software or data.

In alternative embodiments, the storage devices 1608 may include other similar instrumentalities for allowing computer programs or other instructions or data to be loaded into the computing system 1600. Such instrumentalities may include, for example, a removable storage unit 1614 and a storage unit interface 1616, such as a program cartridge and cartridge interface, a removable memory (for example, a flash memory or other removable memory module) and memory slot, and other removable storage units and interfaces that allow software and data to be transferred from the removable storage unit 1614 to the computing system 1600.

The computing system 1600 may also include a communications interface 1618. The communications interface 1618 may be used to allow software and data to be transferred between the computing system 1600 and external devices. Examples of the communications interface 1618 may include a network interface (such as an Ethernet or other NIC card), a communications port (such as for example, a USB port, a micro USB port), Near field Communication (NFC), etc. Software and data transferred via the communications interface 1618 are in the form of signals which may be electronic, electromagnetic, optical, or other signals capable of being received by the communications interface 1618. These signals are provided to the communications interface 1618 via a channel 1620. The channel 1620 may carry signals and may be implemented using a wireless medium, wire or cable, fiber optics, or other communications medium. Some examples of the channel 1620 may include a phone line, a cellular phone link, an RF link, a Bluetooth link, a network interface, a local or wide area network, and other communications channels.

The computing system 1600 may further include Input/Output (I/O) devices 1622. Examples may include, but are not limited to a display, keypad, microphone, audio speakers, vibrating motor, LED lights, etc. The I/O devices 1622 may receive input from a user and also display an output of the computation performed by the processor 1602. In this document, the terms “computer program product” and “computer-readable medium” may be used generally to refer to media such as, for example, the memory 1606, the storage devices 1608, the removable storage unit 1614, or signal(s) on the channel 1620. These and other forms of computer-readable media may be involved in providing one or more sequences of one or more instructions to the processor 1602 for execution. Such instructions, generally referred to as “computer program code” (which may be grouped in the form of computer programs or other groupings), when executed, enable the computing system 1600 to perform features or functions of embodiments of the present invention.

In an embodiment where the elements are implemented using software, the software may be stored in a computer-readable medium and loaded into the computing system 1600 using, for example, the removable storage unit 1614, the media drive 1610 or the communications interface 1618. The control logic (in this example, software instructions or computer program code), when executed by the processor 1602, causes the processor 1602 to perform the functions of the invention as described herein.

Thus, the disclosed method and device try to overcome the technical problem of beverage creation in real time in an efficient and hygienic way. The method and device provide means to create beverages in real-time in front of the user and vends it to the user with minimal human effort. Further, the method and device may offer a transparent window to allow users to engage with the juicing experience. Further, the method and device may dispense the plurality of base beverages and condiments such as but not limited to flavorings, additives, dietary supplements, ice cubes, herbs, nuts, spices, alcohol and the like. Further, the beverage creator device may be modular, thus enabling easy parts replacement for repair, improvement, modification or cleaning. This feature enables the user to easily plug and unplug parts of the beverage creator device for fixing and maintenance thereof. The device may also offer an interactive screen with an in-built scanner, giving a dynamic ordering experience to the user. Further, the device may include a built-in voice recognition feature to allow users contactless interactions. The device also offers beverage customization between base beverages, cold beverages, or regular beverages and selects condiments according to their taste. Further, the device offers a built-in scanner in the touchscreen display to scan items such as but not limited to coupons, discount offers, and payment cards (credit/debit/prepaid/gift/travel cards) to ascertain the details of the customer or user.

As will be appreciated by those skilled in the art, the techniques described in the various embodiments discussed above are not routine, conventional, or well-understood in the art. The techniques discussed above provide for creating beverages in real time. The techniques first receive a first user input through a User Interface (UI). The first user input includes non-confidential user details. The techniques then generate one or more beverage recommendations from a plurality of beverage options based on the first user input using an Artificial Intelligence (AI) model. Further, the techniques receive a second user input through the UI. The second user input includes a beverage selection from the plurality of beverage options. The beverage selection requires one or more food matter 104 from a plurality of food matter for beverage creation. The techniques then cause a receptacle to be placed on the first moving mechanism such as but limited to a conveyor belt and the like to initiate the beverage creation. Further, for each of one or more beverage dispensing sections corresponding to the one or more food matter, the techniques cause the conveyor belt to move the receptacle to a location under a beverage dispenser. Further, the techniques cause the conveyor belt to stop under the beverage dispenser for a predefined time interval. The techniques then cause the beverage dispenser to dispense a beverage into the receptacle.

In light of the above mentioned advantages and the technical advancements provided by the disclosed method and device, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a beverage creator device and method. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description.

Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A beverage creator device to create a beverage of a food matter, comprising:
a plurality of compartments, each compartment comprising:
a container configured to store the food matter;
a beverage-extracting mechanism (201) connected to the container; and
a dual-directional horizontal auger disposed within the container, the dual-directional horizontal auger comprising:
a first coil; and
a second coil,
wherein the first coil and the second coil when rotated collectively in a first direction are configured to transfer the food matter to the beverage-extracting mechanism to create the beverage.

2. The beverage creator device of claim 1, comprising:
a food dispensing mechanism connected to the container,
wherein the first coil and the second coil when rotated collectively in a second direction are configured to transfer the food matter to the food dispensing mechanism.

3. The beverage creator device of claim 1, wherein the container comprises:
a central guide disposed at a base of the container between the first coil and the second coil, wherein the first coil and the second coil guide the food matter to the central guide from the container when rotated in the first direction, wherein the central guide comprises:
a central shutter configured to allow a predefined quantity of the food matter to enter the beverage-extracting mechanism; and
a vertical auger coupled to the beverage-extracting mechanism, wherein the vertical auger is configured to transfer the food matter from the central shutter to the beverage-extracting mechanism.

4. The beverage creator device of claim 2, wherein the beverage extracting mechanism comprises:
a beverage extractor configured to extract beverage of the food matter, the beverage extractor comprising any one of:
a blender;
a centrifugal squeezer;
a masticating squeezer;
a twin-gear squeezer; and
a cold-pressed squeezer;
a beverage dispenser coupled to the beverage extractor, wherein the beverage dispenser is configured to dispense the beverage; and
a waste collector coupled to the beverage extractor configured to receive a food pulp produced after extraction of the beverage from the food matter.

5. The beverage creator device of claim 2, wherein the food dispensing mechanism comprises:
a front shutter connected to the container; and
a food matter dispenser coupled to the front shutter,
wherein the first coil and the second coil guide the food matter to the front shutter when rotated in the second direction.

6. The beverage creator device of claim 1, wherein the container comprises a sub-container configured to store the food matter.

7. The beverage creator device of claim 1, comprising:
a refrigeration unit coupled to each container; and
a water tank coupled to the beverage extracting mechanism, wherein the water tank is configured to pump water to the beverage extracting mechanism to clean the beverage extracting mechanism after the extraction of beverage.

8. The beverage creator device of claim 7, wherein the beverage extracting mechanism comprises:
a conduit coupled to the water tank, wherein the conduit is configured to transmit water from the water tank to the beverage-extracting mechanism for cleaning the beverage extracting mechanism.

9. The beverage creator device of claim 3, comprising:
a first shutter sensor coupled to the central shutter to determine an operational status of the central shutter.

10. The beverage creator device of claim 1, wherein the container comprises:
a plurality of first load sensors configured to weigh a quantity of food matter collected by the central guide; and
a plurality of second load sensors configured to weigh a quantity of food matter collected by the front shutter.

11. The beverage creator device of claim 1, wherein the container comprises:
a temperature sensor configured to monitor a temperature within the container; and
a first gas sensor configured to detect food matter spoilage within the container.

12. The beverage creator device of claim 4, wherein the beverage extracting mechanism comprises:
a waste level sensor configured to detect a level of waste in the waste collector.

13. The beverage creator device of claim 4, wherein the waste collector comprises:
a second gas sensor coupled to the waste collector configured to detect a decay of the food pulp in the waste collector.

14. The beverage creator device of claim 5, wherein the food dispensing mechanism comprises:
a second shutter sensor coupled to the front shutter configured to determine an operational condition of the front shutter.

15. A method of creating a beverage from a food matter, the method comprising:
rotating, in a first direction, a dual-directional horizontal auger (204) disposed in a container configured to store the food matter, wherein the dual-directional horizontal auger comprises:
a first coil; and
a second coil,
wherein the first coil and the second coil when rotated collectively in the first direction is configured to transfer the food matter to a beverage-extracting mechanism for creating the beverage, wherein the beverage-extracting mechanism is coupled to the container.

16. The method of creating the beverage of claim 15, comprising:
rotating collectively, the first coil and the second coil in a second direction for transferring the food matter to a food matter dispenser coupled to the container.

17. The method of creating the beverage of claim 15, comprising:
guiding, the food matter, by rotating the first coil and the second coil about the first direction through a central guide, wherein the central guide is disposed between the first coil and the second coil, wherein the central guide comprises:
a central shutter configured to allow a predefined quantity of the food matter to enter the beverage-extracting mechanism, wherein the central shutter comprises a first shutter sensor configured to determine an operational status of the central shutter; and
a vertical auger coupled to the beverage-extracting mechanism, wherein the vertical auger is configured to transfer the food matter from the central shutter to the beverage-extracting mechanism.

18. The method of creating the beverage of claim 17, comprising:
extracting, using a beverage extractor of the beverage extracting mechanism, the beverage of the food matter, the beverage extractor comprising any one of:
a blender;
a centrifugal squeezer;
a masticating squeezer;
a twin gear squeezer; and
a cold pressed squeezer;
dispensing, by a beverage dispenser (244) coupled to the beverage extractor, the beverage; and
collecting, by a waste collector coupled to the beverage extractor a food pulp of the food matter produced after extraction of the beverage from the food matter, wherein the waste collector comprises:
a waste level sensor configured to detect a level of waste in the waste collector; and
a second gas sensor configured to detect a decay of the food pulp in the waste collector.

19. The method of creating the beverage of claim 16, comprising:
guiding, by rotating the first coil and the second coil in the second direction, the food matter to a front shutter to dispense the food matter via a food matter dispenser, wherein the front shutter comprises a second shutter sensor configured to determine an operational condition of the front shutter,
wherein the front shutter is connected to the container, and
the food matter dispenser is coupled to the front shutter.

20. The method of creating the beverage of claim 17, wherein the container comprises:
a sub-container configured to store the food matter;
a plurality of first load sensors configured to weigh a quantity of food matter collected by the central guide;
a plurality of second load sensors configured to weigh a quantity of food matter collected by the front shutter;
a temperature sensor configured to monitor a temperature within the container; and
a first gas sensor configured to detect food matter spoilage within the container.

21. The method of creating the beverage of claim 15, comprising:
a refrigeration unit coupled to each container;
a water tank coupled to the beverage extracting mechanism, wherein the water tank is configured to pump water to the beverage extracting mechanism to clean the beverage extracting mechanism after the extraction of the beverage; and
a conduit coupled to the water tank, wherein the conduit is configured to transmit water from the water tank to the beverage-extracting mechanism for cleaning the beverage extracting mechanism.
